(19) United States
(12) Patent Application Publication
(10) Pub. No.: US 2026/0200052 A1
(43) Pub. Date: Jul. 16, 2026

(54) MULTIFUNCTIONAL FIREARM MAINTENANCE TOOL

(71) Applicant: Kevin Joseph Blake, Dothan, AL (US)

(72) Inventor: Kevin Joseph Blake, Dothan, AL (US)

(21) Appl. No.: 19/284,632

(22) Filed: Jul. 29, 2025

Related U.S. Application Data
(60) Provisional application No. 63/687,780, filed on Aug. 28, 2024.

(51) Int. Cl. B25B 27/02; F41C 27/00

(52) U.S. Cl. CPC B25B 27/02; F41C 27/00

(57) ABSTRACT

A compact, multifunctional firearm maintenance tool engineered for the assembly and disassembly of AR-10/15, M16, and M4 platform firearms. The invention provides a single, robust fixture that securely attaches to a firearm's lower receiver to guide critical operations, thereby solving the prevalent problems of component misalignment, marring of protective finishes, and loss of small parts. By integrating three distinct gunsmithing functions—guiding the installation of the bolt catch pin, providing a manual press for bolt ejector compression, and ensuring the alignment of the trigger assembly—the tool provides a comprehensive solution not present in prior art. The design offers superior stability, precision, and protection compared to conventional methods and existing single-function tools.

### FIELD OF DISCLOSURE

The present disclosure relates generally to gunsmithing tools and methods, and more particularly to a multi-tool fixture for servicing firearms, specifically adapted for comprehensive maintenance of a trigger, bolt catch, and bolt ejector mechanisms within Modern Sporting Rifles.

### BACKGROUND OF THE INVENTION

The assembly, maintenance, and modification of AR-15/M16/M4 type firearms (collectively, “Modern Sporting Rifles” or MSRs) involve several delicate operations that are notoriously difficult to perform without specialized equipment. The installation of the bolt catch, the trigger assembly, and the bolt ejector are principal examples of such tasks. Conventional methods often require a combination of a vise, hammer, three hands and various punches, demanding a high degree of manual dexterity. These methods are highly susceptible to error, frequently leading to slippage that can scratch, mar, or otherwise damage the protective finish of the firearm's receiver. While rudimentary solutions like applying masking tape exist, they offer unreliable protection.

The challenges associated with these tasks have led to the development of various tools, yet none offer a complete, integrated solution. The prior art can be categorized into several groups, each with significant deficiencies.

A first category includes simple hand tools like punch sets, such as those offered by Wheeler Engineering and Real Avid. While necessary, standard punches offer no guidance or support for the workpiece, placing the burden of alignment entirely on the user and providing no inherent protection against marring the receiver.

A second category includes dedicated bolt servicing tools, as disclosed in U.S. Pat. No. 10,845,115B2 to Chmiel and U.S. Pat. No. 8,572,886B2 to McQueen, or sold commercially as the “Fix It Sticks AR Ejector & Extractor Tool”. These tools effectively solve the single problem of compressing the bolt ejector spring to allow for removal of its retention pin. However, their critical limitation is their singular focus; they are incapable of assisting with any other maintenance task, such as installing the bolt catch or aligning the trigger group, forcing the user to acquire multiple, separate tools.

A third category comprises jigs designed to assist with roll pin installation, most notably for the bolt catch. The “Roll Pin Wizard” tool, representative of the art disclosed in U.S. Pat. No. 9,157,675B1 to Kaufman et al. and U.S. Pat. No. 8,230,623B1 to Nelson, provides a guide for the bolt catch pin. However, these tools exhibit several weaknesses. They are often constructed from injection-molded plastic, which can lack the durability required for repeated use and may fail under pressure due to inherent geometry, leading to tool breakage and potential damage to the firearm. Furthermore, they typically lack features like magnetic pin retention and often use a single-point attachment method to the receiver, which can be less stable than a multi-point fixture. Crucially, like the bolt tools, they are single-function devices.

A final category includes general-purpose multifunctional gunsmithing tools, such as the one disclosed in U.S. Pat. No. 8,479,427B2 to Eley. While these tools combine multiple functions, they typically do so as a collection of separate features in a single device, rather than as an integrated, receiver-mounted fixture that provides guided precision for multiple, distinct assembly operations.

Therefore, there exists a significant and long-felt need for a single, robust, and precise tool fixture that remedies the foregoing problems. An ideal solution would securely attach to the firearm's receiver, provide integrated and guided support for multiple critical tasks (bolt catch, bolt ejector, and trigger assembly), prevent damage to the receiver finish, and be constructed of durable materials. The present invention addresses this unmet need by providing a novel, truly multifunctional fixture that combines these disparate functions into one cohesive and easy-to-use device.

### SUMMARY OF THE INVENTION

The present invention provides a solution to the aforementioned problems in the form of a single, robust, multifunctional firearm maintenance tool. The tool is configured as a fixture that removably and securely attaches to a firearm receiver, creating a stable, guided platform for multiple distinct maintenance operations. This unique configuration prevents damage to the firearm's finish, ensures component precision, and simplifies historically complex assembly tasks.

The invention's novelty is expressed through the integration of three primary functions into this single fixture:

First, in one aspect, the invention provides a guided fixture for installing or removing a bolt catch pin. A precision punch guide aperture, aligned with the receiver's pin holes, directs a punch and pin with high accuracy. This function is enhanced by an integrated magnetic retention system that secures both the punch and the steel pin, preventing accidental slips, marring, and the loss of small parts.

Second, in another aspect, the invention incorporates an integrated press for servicing a bolt ejector. The tool body includes a specially-designed recess to securely cradle a firearm's bolt. A manual compression mechanism allows a user to safely and controllably compress the bolt's ejector and spring, enabling easy removal of the retention pin without the common risk of parts launching under spring tension.

Third, in yet another aspect, the tool functions as an alignment guide for installing a trigger assembly. A temporary alignment pin, held and guided by the tool's body, maintains the perfect orientation of the trigger and disconnector within the receiver. This allows a permanent axis pin to be installed smoothly in a direct, pin-for-pin exchange that preserves critical alignment throughout the process.

The inventiveness lies not only in these individual solutions but in their seamless integration. By combining these functions into one receiver-mounted fixture, the tool provides a level of stability, control, and user convenience that cannot be achieved by using the disparate, single-function tools found in the prior art.

### BRIEF DESCRIPTION OF THE DRAWINGS

FIG. 1 is an isometric view of the TEC Tool Main Body (1) attached to an AR-10/15 Lower Receiver (10), showing the general setup for a bolt catch pin installation operation.

FIG. 2 shows various views and cross-sections of the TEC Tool Main Body (1), highlighting internal apertures and features.

FIG. 3 depicts multiple views of the Manual Compression Knob (14), including its structural features.

FIG. 4 illustrates the TEC Tool Main Body (1) in an operational state for compressing a bolt ejector and spring (30) within an AR-10/15 Bolt Body (19).

FIG. 5 provides an exploded and cross-sectional view of the TEC Tool Main Body (1) configured for bolt catch (11) installation, highlighting internal components and their arrangement.

FIG. 6 is a view of the TEC Tool Main Body (1) installed on an AR-10/15 Lower Receiver (10), illustrating the initial stage of installing the bolt catch (11) and bolt catch pin (29), where the bolt catch pin (29) has been inserted into the TEC Tool (1) and positioned for entry into the AR-10/15 Lower Receiver Bolt Catch Pin Aperture (34).

FIG. 7 depicts the TEC Tool Main Body (1) and AR-10/15 Lower Receiver (10), showing the bolt catch pin (29) fully installed into the AR-10/15 Lower Receiver Bolt Catch Pin Aperture (34) and actively retaining the bolt catch (11) onto the lower receiver (10).

FIG. 8 illustrates the TEC Tool Main Body (1) installed on an AR-10/15 Lower Receiver (10) during the process of removing the bolt catch pin (29) from the AR-10/15 Lower Receiver Bolt Catch Pin Aperture (34) in the lower receiver (10), enabling the bolt catch (11) to be removed for service.

FIG. 9 shows the TEC Tool Main Body (1) being used to assist with installing the disconnector (32) and trigger (12) into the AR-10/15 Lower Receiver (10), specifically illustrating the trigger axis pin (33) being used to push the trigger alignment pin (24) from the lower receiver (10), maintaining component alignment through pin-to-pin contact throughout the installation process.

### DETAILED DESCRIPTION OF THE INVENTION

The Trigger Ejector and Catch (TEC) Tool is a compact, multifunctional device specifically engineered for the precise installation, removal, and maintenance of critical components on AR-10/15, M16, and M4 firearm platforms. Designed to enhance both the efficiency and safety of firearm maintenance tasks, the TEC Tool directly addresses common challenges faced by armorers and enthusiasts, such as the risk of misalignment, marring of sensitive firearm surfaces, and potential damage to pins and components during assembly or disassembly. Its integrated design mitigates common frustrations, offering enhanced control and stability for tasks including, but not limited to, bolt catch pin installation/removal, bolt ejector compression, and trigger/disconnector alignment. It is to be understood that any components depicted in the drawings with dashed or broken lines, such as the AR-10/15 Lower Receiver (10), Bolt Catch (11), and other associated firearm parts, illustrate the environment in which the invention operates and do not form a part of the claimed invention itself.

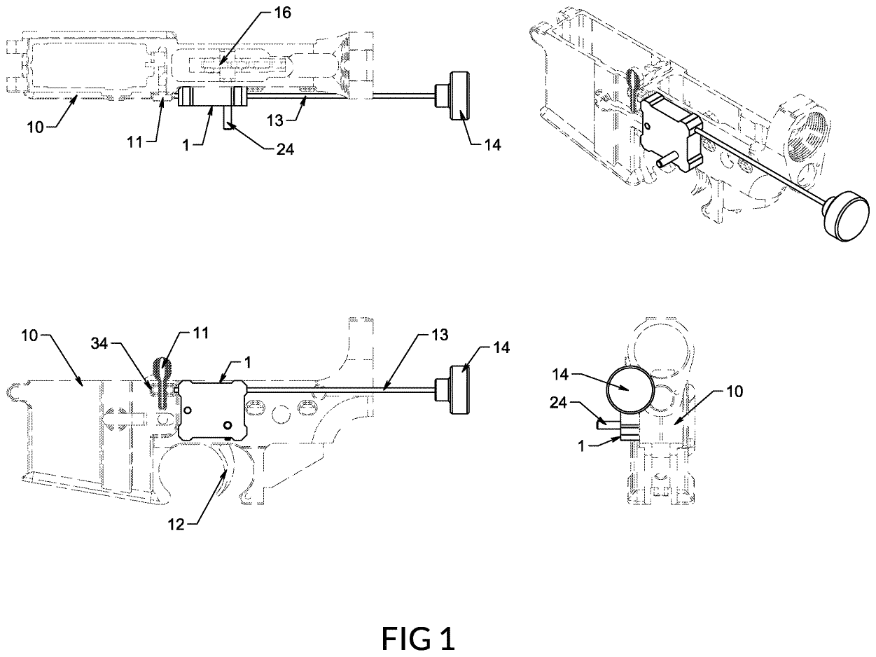

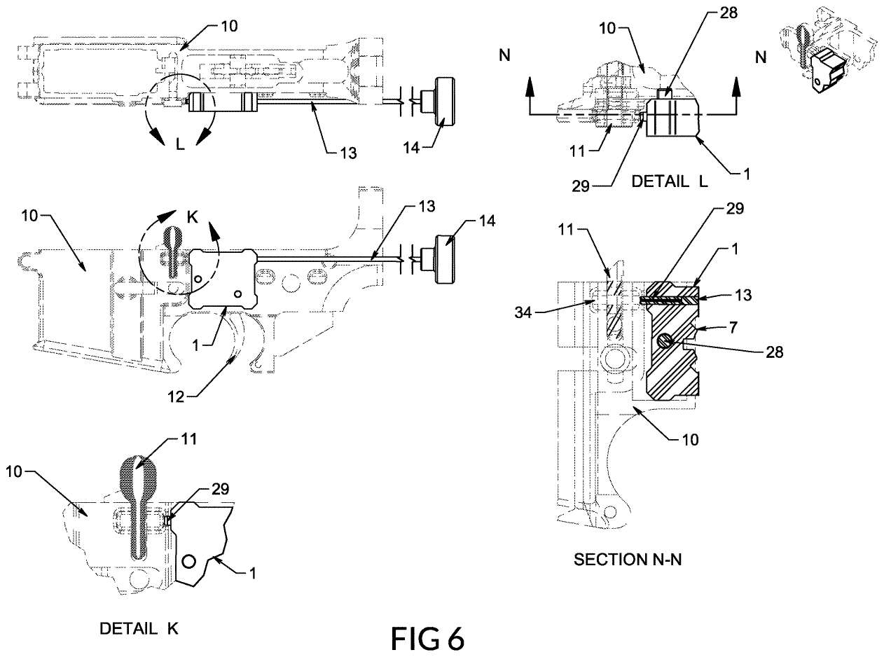

Referring to FIG. 1, the TEC Tool Main Body (1) is depicted in operational use installed on an AR-10/15 Lower Receiver (10), specifically for the process of installing or removing a Bolt Catch Pin (29) (shown in FIG. 6). The TEC Tool Main Body (1) is configured to securely attach to the Lower Receiver (10) by engaging existing axis pin holes (e.g., the trigger and hammer pin holes), ensuring a stable and aligned platform for subsequent operations. A Punch (13) is shown extending through the TEC Tool Main Body (1), positioned perpendicular to the plane of attachment to the Lower Receiver (10). A Bolt Catch (11) is shown in relation to the Lower Receiver (10). The TEC Tool Main Body (1) is uniquely designed to precisely align and hold the Bolt Catch (11) in position as the Bolt Catch Pin (29) (shown in FIG. 6) is installed, thereby streamlining the assembly process and preventing misaligned components. A Manual Compression Knob (14) is optionally situated at the end of the Punch (13), providing a comfortable Handling Surface (27) and allowing for manual insertion of pins or serving as a wider interface for striking with a hammer. A Trigger Alignment Pin (24) is seen extending from the Main Body (1) to engage with the Complete Trigger Assembly (16) within the Lower Receiver (10). A Bolt Catch Pin Aperture (34) is visible on the Lower Receiver (10), positioned to align with the Bolt Catch (11).

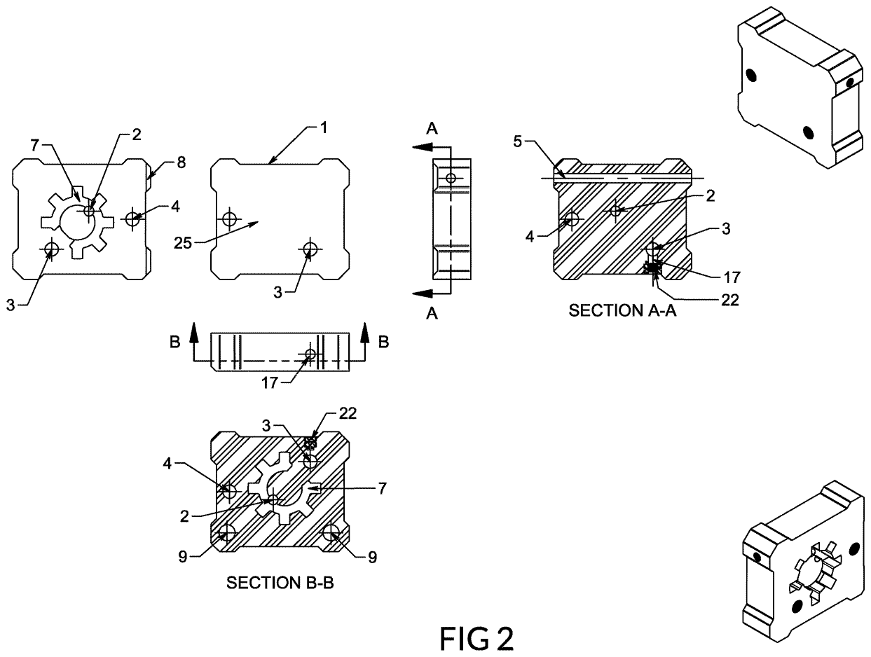

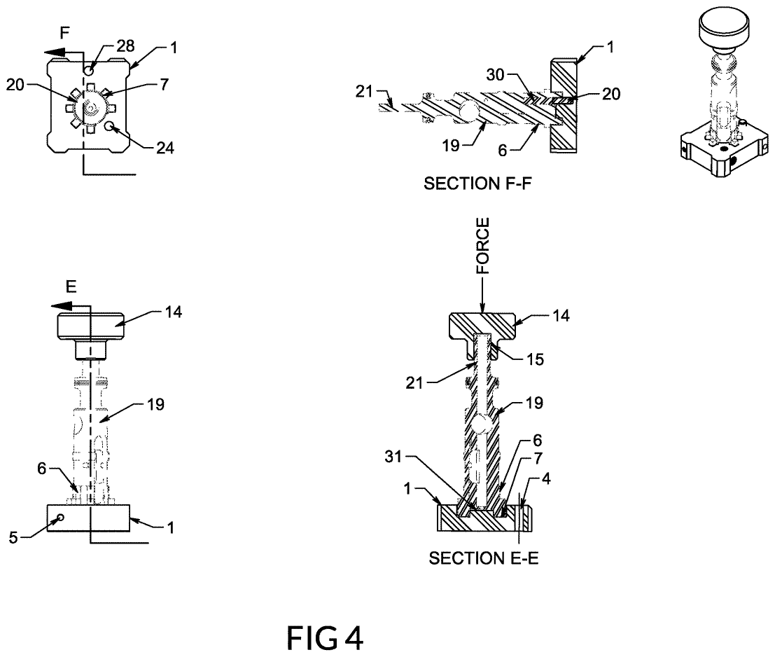

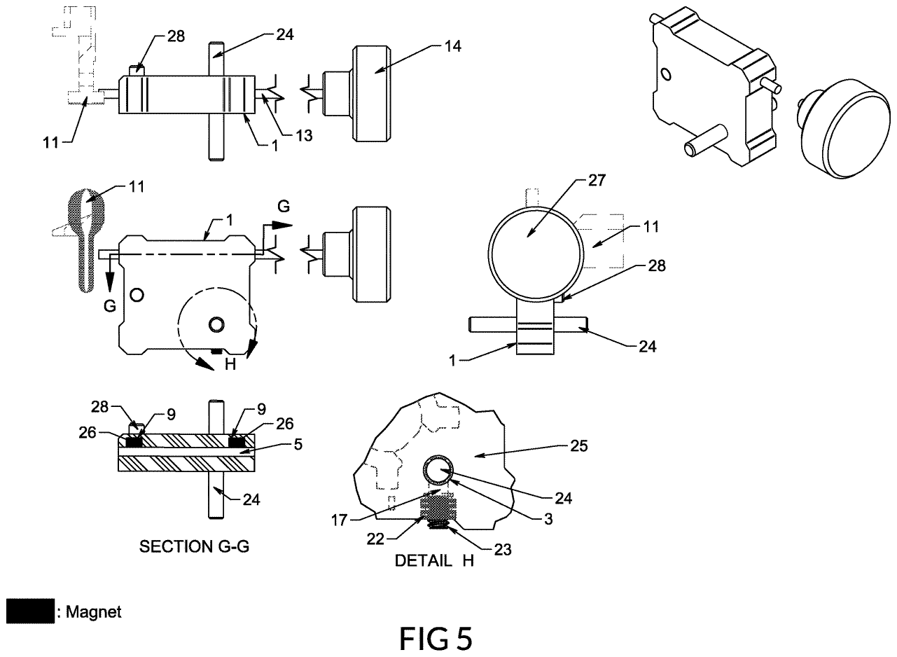

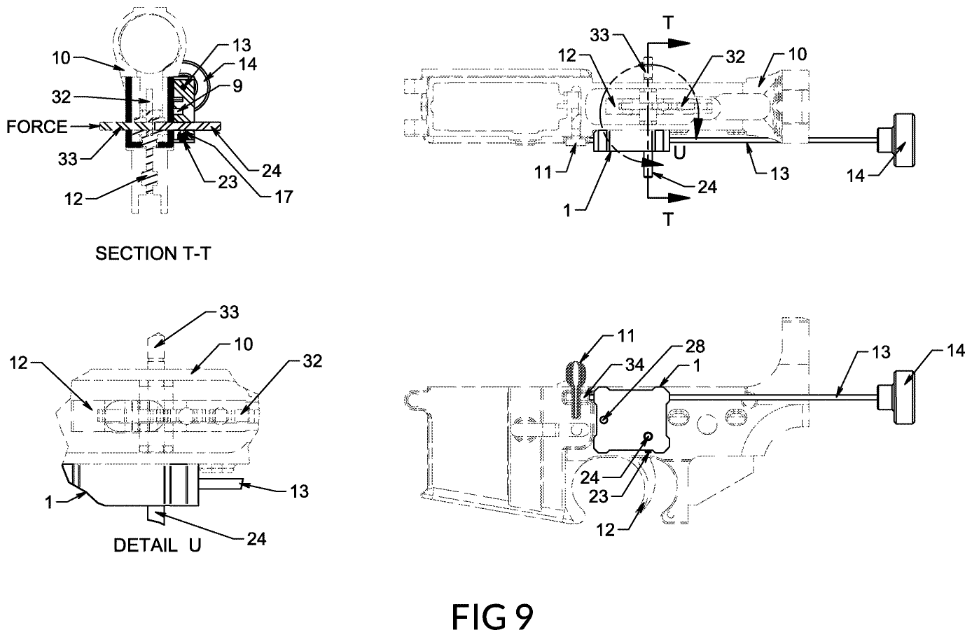

As depicted in FIG. 2, various views of the TEC Tool Main Body (1) are provided to illustrate its structural and functional features. An Inscription Surface (25) is provided on the front face of the Main Body (1), suitable for branding or product identification. The rear of the Main Body (1) incorporates a Bolt Face Recess (7), precisely shaped with a plurality of slots designed to interface securely with the locking lugs of an AR-10/15 Bolt Body (19) (shown in FIG. 4). This recess facilitates stable positioning of the bolt for maintenance operations. A Bolt Ejector Compression Pin Aperture (2) is strategically located to align with and accommodate a Bolt Ejector Compression Pin (20) (shown in FIG. 4) when a bolt is inserted into the recess, ensuring precise pin alignment. A Hammer Alignment Pin Aperture (4) extends through the Main Body (1), designed to guide and retain the included Hammer Alignment Pin (28) (shown in FIG. 5) for specific assembly tasks, maintaining proper orientation of the existing hammer axis pin hole within the lower receiver. Furthermore, a Trigger Alignment Pin Aperture (3) is included for similar guidance of a Trigger Alignment Pin (24) (shown in FIGS. 5, 9), facilitating accurate trigger group installation. The Main Body (1) also features a Chamfered Surface (8) along its periphery, specifically positioned to provide essential clearance with the AR-10/15 Lower Receiver (10) during attachment and use. This Chamfered Surface (8) rises above the typical variation range of fillets commonly manufactured into the finished Lower Receiver (10), thereby ensuring that the TEC Tool seats flawlessly and consistently on any such receiver, preventing interference or marring despite minor manufacturing variances across different producers.

Continuing with FIG. 2, Section A-A provides a cross-sectional view illustrating the Punch Guide Aperture (5), which serves as a highly precise channel for guiding the Punch (13) and a Bolt Catch Pin (29) during installation or removal. Also visible in Section A-A are a Set Screw Aperture (17) and its Threaded Feature (22), which allow for the insertion and retention of a Set Screw (23) (shown in FIG. 5). Section B-B further reveals Embedded Punch Magnet Recesses (9) within the Main Body (1). These recesses house Punch Magnets (26) (shown in FIG. 5), which are strategically positioned to magnetize the Punch Guide Aperture (5) and thereby enhance the retention of the Punch (13) and any steel pins inserted through it, preventing pins from being lost or misaligned during the installation process.

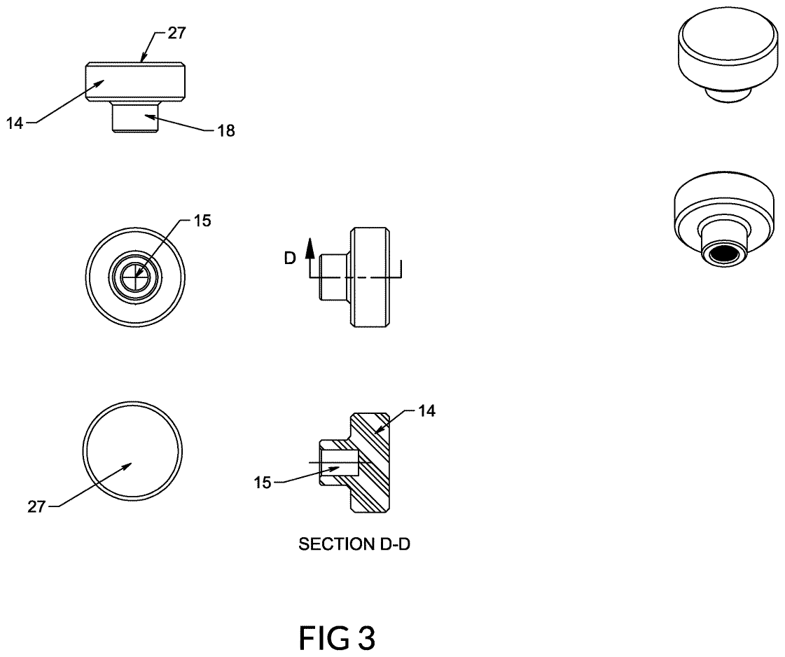

Referring to FIG. 3, various views of the Manual Compression Knob (14) are shown. The Handling Surface (27) of the Manual Compression Knob (14) is designed to comfortably interface with a user's hand, or other suitable means of compression, allowing for controlled application of force. The Bolt Compression Knob Neck (18) extends from the main body of the knob, providing essential clearance for various components of the firearm during maintenance, and typically comprises half or more of the radius of the manual compression knob. A Bolt Tail Interface Aperture (15) is centrally located within the knob, specifically designed to assist with the smooth insertion of a Punch (13) or an AR-10/15 Bolt Tail (21) (as shown in FIG. 4), ensuring proper alignment during bolt compression.

Referring to FIG. 4, an embodiment of the TEC Tool is illustrated in use for the critical task of removing a Bolt Ejector Retention Pin (6) from an AR-10/15 Bolt Body (19). The AR-10/15 Bolt Body (19) is securely inserted into the Bolt Face Recess (7) on the TEC Tool Main Body (1), ensuring the bolt is held firmly in place without slippage. Subsequently, the Manual Compression Knob (14) is positioned onto the AR-10/15 Bolt Tail (21), with the Bolt Tail Interface Aperture (15) providing proper alignment. Manual pressure applied to the Manual Compression Knob (14) forces the AR-10/15 Bolt Body (19) deeper into the Main Body (1), compressing the bolt ejector. Within this compressed state, the Bolt Ejector Compression Pin (20) (located within the Main Body (1) and shown interacting with the bolt in Section F-F) forces the Bolt Ejector and Spring (30) rearward. In this compressed state, the user would use the palm of their hand to apply force on the manual compression knob 14, while holding a small punch with their fingers. The punch could then be inserted onto the face of the Bolt Ejector Retention Pin (6) and removed with a hammer by the user. This precise compression holds the ejector and spring under tension, allowing for safe and easy removal of the Bolt Ejector Retention Pin (6) without the common risk of parts inadvertently launching across the workspace, which is a significant safety and convenience improvement. Section E-E of FIG. 4 clearly demonstrates how the stabilizing walls of the Bolt Face Recess (7) and the AR-10/15 Case Head Recess Surface (31) ensure the AR-10/15 Bolt Body (19) remains stable and properly aligned, preventing slippage or tilting while under compression. Section F-F further illustrates the precise interaction of Bolt Ejector Compression Pin (20) with the AR-10/15 Bolt Body (19) and the Bolt Ejector and Spring (30).

Referring to FIG. 5, an embodiment of the TEC Tool is configured for the precise installation of a Bolt Catch (11). In this configuration, Detail H illustrates the Trigger Alignment Pin (24) interfacing with the Trigger Alignment Pin Aperture (3). A Set Screw (23) is shown interfaced with a Threaded Feature (22) within a Set Screw Aperture (17), where the Set Screw (23) applies slight, adjustable pressure to the Trigger Alignment Pin (24) to temporarily maintain its position during assembly (e.g., when installing a Bolt Catch (11)). Section G-G provides a top view of the TEC Tool Main Body (1), clearly showing the position of the Punch Magnets (26) housed within Embedded Punch Magnet Recesses (9) relative to the Punch Guide Aperture (5). The primary view of FIG. 5 demonstrates the overall setup for bolt catch installation, where a Bolt Catch (11) is shown in position to be properly oriented by the TEC Tool. The Punch (13) is shown extending through the Main Body (1), positioned perpendicular to the interface with the Lower Receiver (10) (not fully pictured), ready to engage a Bolt Catch Pin (29) (as shown in FIG. 6). The Manual Compression Knob (14) is installed on the end of the Punch (13) for user interface, with its Handling Surface (27) providing ergonomic control. The Hammer Alignment Pin (28) is also shown in its respective aperture, ensuring proper alignment of the tool with the receiver.

Referring to FIG. 6, the TEC Tool mechanism is shown in a state where a Bolt Catch Pin (29) is positioned for insertion into the Bolt Catch Pin Aperture (34) on an AR-10/15 Lower Receiver (10). While the Bolt Catch (11) is held in its approximate location against the receiver by the user, the rigid attachment of the TEC Tool Main Body (1) provides a stable platform that guarantees perfect alignment for the pin's path. A Hammer Alignment Pin (28) is shown in position within its aperture. Section N-N displays a cross-sectional view of this process from the front, where the Punch (13) is precisely interfaced with the Bolt Catch Pin (29). The Punch Magnets (26) (visible in FIG. 5) housed within the Main Body (1) apply magnetic force to the Punch (13), thereby securely retaining the Bolt Catch Pin (29) to the end of the Punch (13) prior to and during insertion, preventing fumbling or dropping and ensuring smooth installation. Detail K further illustrates the alignment of the Bolt Catch (11) and Bolt Catch Pin (29) within the Lower Receiver (10) through the tool.

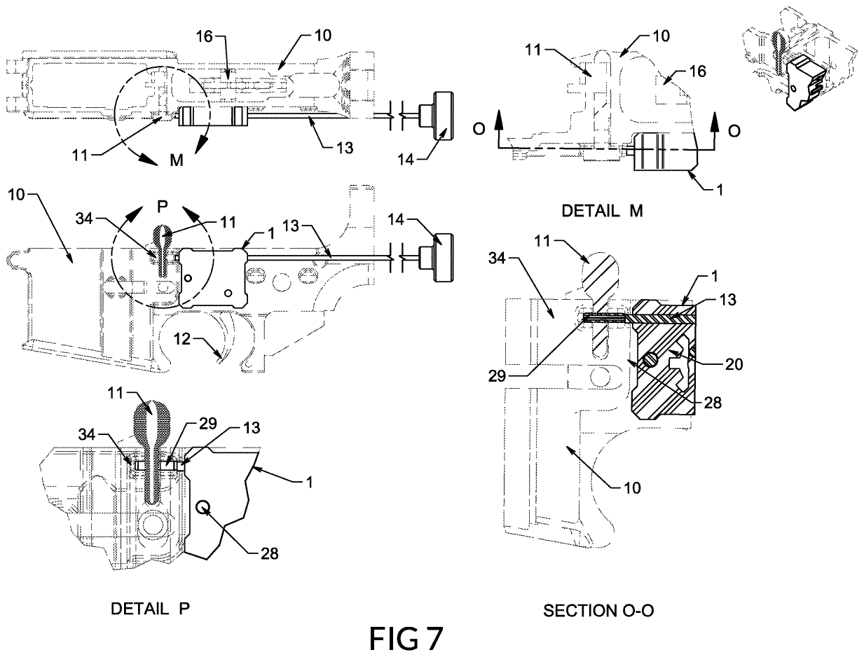

Referring to FIG. 7, the embodiment shown in FIG. 6 progresses to a state where the Bolt Catch Pin (29) has been successfully installed into the AR-10/15 Lower Receiver (10), thereby securely retaining the Bolt Catch (11). Detail M illustrates a top view of the TEC Tool Main Body (1) in relation to the Bolt Catch (11) and Lower Receiver (10), with the Complete Trigger Assembly (16) also depicted in context. The Bolt Catch Pin (29) (as it is driven into place by the Punch (13)) secures the Bolt Catch (11) in its final position. Once the Bolt Catch Pin (29) is fully seated, the TEC Tool Main Body (1) can be disengaged and removed from the Lower Receiver (10), leaving the Bolt Catch (11) securely installed. Section O-O provides a front cross-sectional view of this process, highlighting the interaction of the Punch (13), Bolt Catch Pin (29), and the Bolt Catch (11) as it is secured within the Lower Receiver (10). The Hammer Alignment Pin (28) is shown providing additional stability during the process. Detail P provides an additional close-up of this interaction, as well shown in Section O-O.

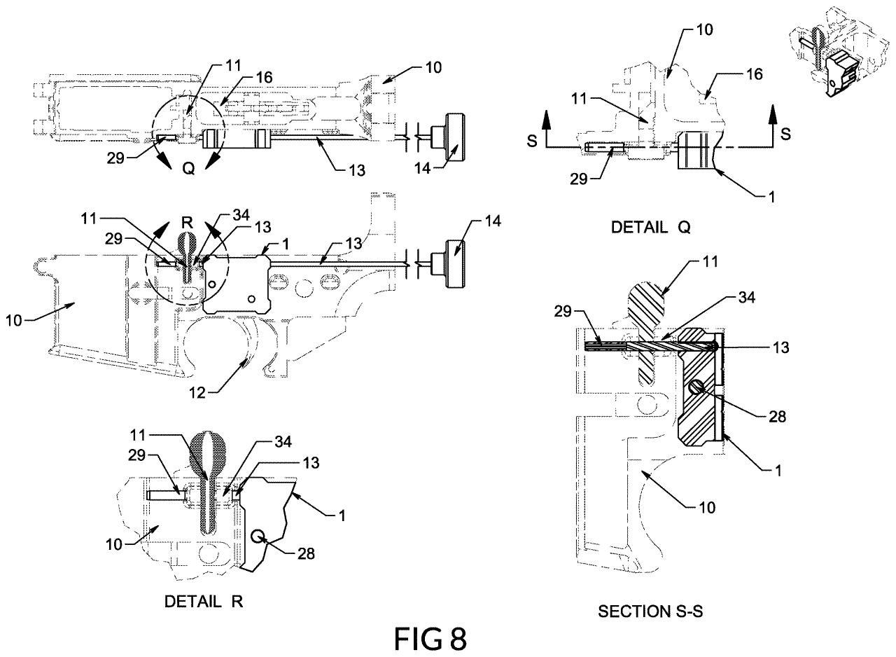

Referring to FIG. 8, the TEC Tool is illustrated in a state for the disassembly and removal of the Bolt Catch Pin (29) from the AR-10/15 Lower Receiver (10). Section S-S demonstrates the engagement of the Punch (13) with the Bolt Catch Pin (29). The TEC Tool Main Body (1) mechanism is securely installed on the Lower Receiver (10), and the Punch (13), manipulated by the Manual Compression Knob (14), is used to precisely drive the Bolt Catch Pin (29) out of the Lower Receiver (10). This process allows for the release of the Bolt Catch (11) for service, repair, or replacement with minimal effort and risk of damage to the Lower Receiver (10) or the Bolt Catch (11) itself. Section S-S provides a front cross-sectional view of this disassembly process, clearly showing the Punch (13) interfacing directly with the Bolt Catch Pin (29) as it is pushed clear from the Lower Receiver (10). Detail Q offers an additional perspective on the tool's interaction during removal.

Referring to FIG. 9, the TEC Tool Main Body (1) is utilized to effectively assist with the installation of the Disconnector (32) and Trigger (12) onto the AR-10/15 Lower Receiver (10), providing a stable guide for these often finicky components. Detail U provides a top view of this precise operation, where the user is guiding a Trigger Axis Pin (33) through the appropriate aperture on the right side of the Lower Receiver (10). As the Trigger Axis Pin (33) is driven into position, it smoothly forces the Trigger Alignment Pin (24) through the Trigger Alignment Pin Aperture (3) of the Main Body (1). Section T-T offers an illustrative cross-sectional representation of this process, emphasizing how the Set Screw (23) (when not engaged to apply pressure via its Threaded Feature (22)) allows the Trigger Alignment Pin (24) to move freely within the Trigger Alignment Pin Aperture (3). This design ensures that as the Trigger Axis Pin (33) is driven home, the Trigger (12) and Disconnector (32) remain perfectly seated and aligned within the Lower Receiver (10), preventing common installation issues such as parts rotating out of alignment or springs becoming dislodged, thus simplifying a frequently challenging assembly step.

Materials and Manufacturing The components of the TEC Tool, particularly the TEC Tool Main Body (1) and Manual Compression Knob (14), may be constructed from a variety of durable materials selected for their strength, rigidity, and cost-effectiveness. Suitable materials include, but are not limited to, fiber-reinforced polymers, high-strength plastics, aluminum alloys, and various grades of steel. The manufacturing processes for these components can also vary, encompassing methods such as 3D printing (additive manufacturing), CNC machining, injection molding, or die casting, allowing for flexibility in production to meet specific requirements for precision and volume.

What is claimed is:

1. A multifunctional firearm maintenance tool comprising:
a) a main body (1) configured to removably attach to an AR-10/15 Lower Receiver (10) by engaging existing axis pin holes, said main body (1) further configured to align a bolt catch (11) in relation to a Bolt Catch Pin Aperture (34) during installation of a bolt catch pin (29);
b) a punch guide aperture (5) extending through the main body (1), configured to precisely guide a punch (13) for installation or removal of the bolt catch pin (29) from the lower receiver (10), said punch guide aperture (5) including embedded punch magnet recesses (9) housing punch magnets (26) configured to magnetize the punch (13) for enhancing retention of the bolt catch pin (29); and
c) a manual compression mechanism for servicing an AR-10/15 Bolt Body (19), the manual compression mechanism comprising:
i. a bolt face recess (7) on the main body (1) configured to receive and stabilize an AR-10/15 Bolt Body (19) by interfacing with an AR-10/15 Case Head Recess Surface (31) of the AR-10/15 Bolt Body (19);
ii. a manual compression knob (14) configured to interface with an AR-10/15 Bolt Tail (21) via a bolt tail interface aperture (15); and
iii. a bolt ejector compression pin (20) extending from the main body (1) within the bolt face recess (7), configured to engage and compress a bolt ejector and spring (30) within the AR-10/15 Bolt Body (19), thereby allowing for removal of a bolt ejector retention pin (6) without uncontrolled ejection of said bolt ejector and spring (30).

2. The tool of claim 1, wherein the main body (1) further comprises a trigger alignment pin aperture (3) configured to guide a trigger alignment pin (24) for aligning a trigger (12) and a disconnector (32) during installation of a trigger axis pin (33) in the lower receiver (10).

3. The tool of claim 2, further comprising a set screw aperture (17) with a threaded feature (22) in communication with the trigger alignment pin aperture (3), wherein a set screw (23) is configured to be inserted into the set screw aperture (17) to apply adjustable pressure to the trigger alignment pin (24) to maintain its position.

4. The tool of claim 1, wherein the punch guide aperture (5) includes a chamfered and counter-bored entry to facilitate smooth insertion of the bolt catch pin (29).

5. The tool of claim 1, wherein the manual compression knob (14) includes a handling surface (27) configured to interface with a user's hand or a vise.

6. The tool of claim 1, wherein the manual compression knob (14) includes a bolt compression knob neck (18) designed to provide clearance for various components of the firearm during maintenance.

7. The tool of claim 1, wherein the main body (1) includes a chamfered surface (8) configured to provide clearance with fillets of varying sizes on the AR-10/15 Lower Receiver (10), ensuring consistent and stable seating of the main body (1) and preventing marring of said lower receiver (10).

8. The tool of claim 1, further comprising a hammer alignment pin aperture (4) extending through the main body (1), configured to guide an included hammer alignment pin (28) for aligning a hammer during installation or disassembly of firearm components.

9. The tool of claim 1, wherein the punch (13) is configured to extend past the rear part of the lower receiver (10) to prevent marring of surfaces in the event of a tool slip during pin installation or removal.

10. The tool of claim 1, wherein the main body (1) is constructed from a material selected from the group consisting of fiber-reinforced polymers, high-strength plastics, aluminum, steel or suitable material.

11. The tool of claim 1, wherein the tool is manufactured by a process selected from the group consisting of 3D printing, CNC machining, injection molding, or by any feasible means of manufacturing.

12. A firearm maintenance system comprising:
a) an AR-10/15 Lower Receiver (10) having a Bolt Catch Pin Aperture (34); and
b) a tool for precisely installing a bolt catch pin (29) into the lower receiver (10), the tool comprising:
i. a main body (1) configured to removably attach to the lower receiver (10);
ii. a punch guide aperture (5) extending through the main body (1), aligned with the Bolt Catch Pin Aperture (34); and
iii. an internal magnetic retention system including embedded punch magnet recesses (9) housing punch magnets (26) configured to magnetize a punch (13) for securely retaining the bolt catch pin (29) to the punch (13) prior to insertion through the punch guide aperture (5).

13. The system of claim 12, wherein the main body (1) is further configured to align a bolt catch (11) in relation to the Bolt Catch Pin Aperture (34) as the bolt catch pin (29) is guided through the punch guide aperture (5).

14. A method for maintaining a firearm, the method comprising:
a) attaching a TEC Tool Main Body (1) to an AR-10/15 Lower Receiver (10);
b) inserting an AR-10/15 Bolt Body (19) into a bolt face recess (7) of the TEC Tool Main Body (1);
c) applying pressure to an AR-10/15 Bolt Tail (21) via a manual compression knob (14) to compress a bolt ejector and spring (30) within the AR-10/15 Bolt Body (19) by engagement with a bolt ejector compression pin (20) extending from the TEC Tool Main Body (1); and
d) removing a bolt ejector retention pin (6) from the AR-10/15 Bolt Body (19) while the bolt ejector and spring (30) are compressed, thereby preventing uncontrolled ejection of said bolt ejector and spring (30).

15. The method of claim 14, further comprising:
e) aligning a bolt catch (11) on the AR-10/15 Lower Receiver (10) using the TEC Tool Main Body (1) and a Bolt Catch Pin Aperture (34); and
f) guiding a bolt catch pin (29) through a punch guide aperture (5) of the TEC Tool Main Body (1) using a punch (13) to install the bolt catch pin (29) into the lower receiver (10) to secure the bolt catch (11).

16. The method of claim 15, wherein guiding the bolt catch pin (29) includes utilizing magnetic force imparted from punch magnets (26) within the TEC Tool Main Body (1) to retain the bolt catch pin (29) to the punch (13).

17. The method of claim 14, further comprising:
g) aligning a trigger (12) and a disconnector (32) within the AR-10/15 Lower Receiver (10) by guiding a trigger alignment pin (24) through a trigger alignment pin aperture (3) of the TEC Tool Main Body (1); and
h) driving a trigger axis pin (33) through the lower receiver (10), displacing the trigger alignment pin (24), to install the trigger (12) and disconnector (32), thereby ensuring proper alignment of the complete trigger assembly (16).

18. The method of claim 17, further comprising adjusting a set screw (23) in a set screw aperture (17) to apply pressure to the trigger alignment pin (24) to temporarily hold its position during alignment.

19. The tool of claim 1, wherein the main body (1) further comprises an inscription surface (25) for product identification and branding inscription.

20. The tool of claim 1, further comprising an included hammer alignment pin (28) configured for insertion into the hammer alignment pin aperture (4) to align and retain the main body (1) to the lower receiver (10).
